(19) United States
(12) Patent Application Publication
(10) Pub. No.: US 2018/0027036 A1
(43) Pub. Date: Jan. 25, 2018

(54) CREW MOBILE DEVICE-BASED CONTENT LOADER FOR ENTERTAINMENT SYSTEM

(71) Applicant: Panasonic Avionics Corporation, Lake Forest, CA (US)

(72) Inventors: Philip Watson, Lake Forest, CA (US); Steven Bates, Mission Viejo, CA (US)

(21) Appl. No.: 15/217,860

(22) Filed: Jul. 22, 2016

(51) Int. Cl. H04L 29/06; H04W 84/12; H04B 7/185; H04L 29/08

(52) U.S. Cl. CPC H04L 65/60; H04L 67/1097; H04L 67/12; H04W 84/12; H04B 7/18506

(57) ABSTRACT

A content loader device for transferring multimedia content from a remote content server to an entertainment system of a vehicle includes a content memory and a primary data networking module that establishes a local data transfer link to the entertainment system while being within direct wireless communicable range, and a primary remote data transfer link to the remote content server while being beyond direct wireless communicable range. A data retrieval client, without user intervention and in response to a detected establishment of the primary remote data transfer link, transmits a content reception availability command to the remote content server. In response, the content is transmitted to the data retrieval client based upon a manifest associating the content loader device to the vehicle. A data loading client, without user intervention and in response to a detected establishment of the local data transfer link, transmits the content to the entertainment system.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to data communications devices, and more particularly, to crew mobile device-based content loaders for vehicle entertainment systems.

### 2. Related Art

Air travel typically involves journeys over extended distances that at the very least take several hours to complete. Some of the longer non-stop international flights have scheduled durations of over sixteen hours with travel distances extending beyond ten thousand miles. Passengers on board the aircraft are confined within an enclosed space of a designated seat for the entire duration of the flight, with only a few limited opportunities to leave the seat for use of the lavatory and so forth. Thus, even on the shortest trips an airline passenger has some idle time, which the passenger may occupy with work, leisure, and/or rest.

Many passengers bring their own personal electronic devices such as smart phones, media players, electronic readers, tablets, laptop computers, and so forth, for the express purpose of keeping occupied, but airlines also accommodate its customers with in-flight entertainment and communications (IFEC) systems. Although the specific installation may vary depending on the service class, each passenger seat is equipped with a display device, an audio output modality, an input modality such as a remote control, and a terminal unit. Generally, the terminal unit may generate video and audio signals, receive inputs from the remote control, and execute pre-programmed instructions in response thereto. The display device is typically an LCD screen that is installed on the seatback of the row in front of the passenger, though in some cases it may be mounted to a bulkhead or retractable arm or the like that is in turn mounted to the passenger's seat. Furthermore, the audio output modality is a headphone jack, to which a headphone, either supplied by the airline or by the passenger, may be connected.

Via the display and the audio outputs, a wide variety of multimedia content can be presented to the passenger. Recently released movies are a popular viewing choice, as are television shows such as news programs, situation and stand-up comedies, documentaries, and so on. Useful information about the destination such as airport disembarking procedures, immigration and custom procedures and the like is also frequently presented. Audio-only programming is also available, typically comprised of playlists of songs fitting into a common theme or genre. Likewise, video-only content such as flight progress mapping, flight status displays, and so forth are available. Many in-flight entertainment systems also include video games that may be played by the passenger using the remote control, which may also have alternative uses, namely, for navigating through the vast multimedia content library and making selections thereof for viewing and/or listening. Thus, the terminal unit may also include a content selection application with a graphical user interface, through which such navigation of the multimedia content library is possible. The foregoing types of programming that can be presented to the passenger via the in-flight entertainment system will henceforth be generally referred to as multimedia content.

The multimedia content is encoded and stored as digital data, with a video decoder and audio decoder of the terminal unit functioning to generate the aforementioned video and audio signals therefrom. It is desirable to have a wide range of different multimedia content to satisfy the varying tastes of passengers. It is also desirable to have a sufficient volume of multimedia content so that passengers can remain occupied with entertainment for the entire duration of the flight. Accordingly, the multimedia content stored onboard the aircraft can range in the hundreds of gigabytes, if not over a terabyte. The majority of the data comprises the video programming, although the audio and video game content may be significant as well. This data is typically not stored on each individual terminal unit, but rather, in a central content server also onboard the aircraft. In this regard, the terminal unit is understood to incorporate networking modalities such as Ethernet to establish data communications with the central content server. Once a particular selection of multimedia content is requested by the passenger via the content selection application, the terminal unit may retrieve the same from the central content server, decode the data, and present it to the passenger.

As important as variety and volume may be in regards to the multimedia content, novelty is as important for airlines to keep its passengers engaged with the in-flight entertainment system, particularly for valuable frequent fliers. Thus, the multimedia content stored on the content server must be frequently updated. Due to the large volume of data involved, a portable content loader that is generally comprised of a hard disk drive, an optical drive, or a solid state drive loaded with the update data is physically carried onboard while the aircraft is on the ground and connected to the central content server. A download or copy process is then initiated, and once complete, the portable content loader is disconnected and removed from the aircraft.

In part because of the laborious manual procedures involved, this update process typically takes place on a monthly schedule, preferably during a layover between flights, such as when aircraft maintenance is conducted. It would be desirable for new multimedia content to be made available on a more frequent basis, incorporating programming that may be only days or even a few hours old. Yet, the expense and labor involved with the use of specialized content loader devices may preclude this. These issues are particularly acute for large fleets of aircraft.

Aircraft-installed content loaders that utilize wireless networking for multimedia content retrieval have been developed to address this need for updated content. Such data loaders are powered directly from the aircraft electrical system, and hence only operate while the aircraft is powered on. Wi-Fi, as well as cellular communications modalities are utilized in such content loaders. However, these typically require the aircraft to be parked near the gate, where a Wi-Fi access point or a cellular link is available. The time between each flight during which the aircraft has access to a ground-based Wi-Fi access point or cellular link may be limited, so the amount of content that can be updated may likewise be limited; by most measures, an aircraft spends at most one tenth of its operational life on the ground. Although Wi-Fi access is the least costly because there are no usage charges, setting up an access point at every airport, and for every terminal in the airport at which the aircraft may stop, requires setting up a substantial ground-based infrastructure. Cellular communications, on the other hand, typically have usage costs as well as roaming charges to the extent the aircraft is located in a non-native coverage area.

While satellite downlink-based loaders are also known in the art, a separate, dedicated antenna(s) that typically utilize phased array technology must be installed on the aircraft exterior. There are additional power requirements for such satellite modalities as well, and bandwidth is both limited and costly.

Accordingly, there is a need in the art for an improved content loader device to the in-flight entertainment systems across a fleet of aircraft. There is a need for a crew mobile device-based content loader for the in-flight entertainment system.

### BRIEF SUMMARY

The present disclosure contemplates a content loader for an entertainment system of a vehicle that utilizes personal electronic devices (PEDs) that are issued by airline to various members of the flight crew. Optionally, the transfer of the data both to and from the PEDs can be automated and requires no additional interaction by the crewmember; the crewmember may simply possess the PED in locations where network access to a remote content server is available while away from the aircraft, and the PED begins the content transfer process once connected to the aircraft wireless network when the crewmember comes aboard to conduct flight operations. In one embodiment, a content loader device for transferring multimedia content from a remote content server to an entertainment system of a vehicle is disclosed. The content loader device may include a content memory, as well as a primary data networking module that establishes a local data transfer link to the entertainment system while being within direct wireless communicable range thereto. The primary data networking module also establishes a primary remote data transfer link to the remote content server while being beyond direct wireless communicable range to the entertainment system. There may also be a data retrieval client that is linked to the content memory and the primary data networking module. The data retrieval client, without user intervention and in response to a detected establishment of the primary remote data transfer link, may transmit a content reception availability command to the remote content server over the primary remote data transfer link. In response, the remote content server may transmit the multimedia content to the data retrieval client over the primary remote data transfer link. This transmission may be based upon a manifest associating the content loader device to the vehicle. The multimedia content may be stored in the content memory. The content loader device may also include a data loading client that is linked to the content memory and the primary data networking module. The data loading client, without user intervention and in response to a detected establishment of the local data transfer link, may transmit the multimedia content to the entertainment system following retrieval from the content memory.

According to another embodiment, there is a system for wirelessly distributing multimedia content to an in-flight entertainment system of an aircraft. The system may include a remote content server on which the multimedia content is stored, and one or more content loader devices each assigned to a flight crew member. The content loader devices may each include a data retrieval module that announces an availability to accept the multimedia content from the remote content server upon establishing a remote data communications link to a wide area network connected to the remote content server. In response to the announcement, the remote content server may selectively transmit the multimedia content to a specific one of the one or more content loader devices based upon a crewmember manifest maintained by the remote content server associating the specific one of the one or more content loader devices with the aircraft. The content loader device may also include a data loading module that transmits the multimedia content to the in-flight entertainment system over a local wireless data communications link to the in-flight entertainment system.

Still another embodiment is directed to a method for distributing multimedia content to an in-flight entertainment system of an aircraft. The method may include a step of receiving a first availability announcement from a first content loader device issued to a first aircraft crewmember. The first availability announcement may be received on a content server computer system over a first remote data communications link. Additionally, the first availability announcement may include a first device identifier associated with the first content loader device. There may also be a step of correlating the first device identifier with an aircraft identifier listed in a crewmember manifest stored on the content server computer system. The method may further include transmitting one or more first segments of the multimedia content to the first content loader device. The one or more first segments of the multimedia content may be designated for transmission to an aircraft to which the first device identifier is correlated.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram of an exemplary aircraft environment in which one aspect of the presently disclosed content loader may be utilized;

FIG. 2 is a block diagram showing the various components of a system for wirelessly distributing multimedia content to an in-flight entertainment system;

FIG. 3 is detailed block diagram illustrating the system for wirelessly distributing multimedia content, including the features of a remote content server, a content loader device, and the in-flight entertainment system;

FIG. 4 is a exemplary data structure diagram of a segment of multimedia content that is transferred from the remote content server to the content loader device, and then to the in-flight entertainment system; and

FIGS. 5A and 5B are flowcharts depicting one embodiment of a method for wirelessly distributing content to the in-flight entertainment system.

### DETAILED DESCRIPTION

The present disclosure is directed to wireless content loaders for vehicle entertainment systems, such as an in-flight entertainment for an aircraft. The detailed description set forth below in connection with the appended drawings is intended as a description of the presently preferred embodiments of the content loader, and is not intended to represent the only form in which it can be developed or utilized. The description sets forth the features of the content loader in connection with the illustrated embodiments. It is to be understood, however, that the same or equivalent functions may be accomplished by different embodiments that are also intended to be encompassed with the present disclosure. It is further understood that the use of relational terms such as first, second, and the like are used solely to distinguish one from another entity without necessarily requiring or implying any actual such order or relationship between such entities.

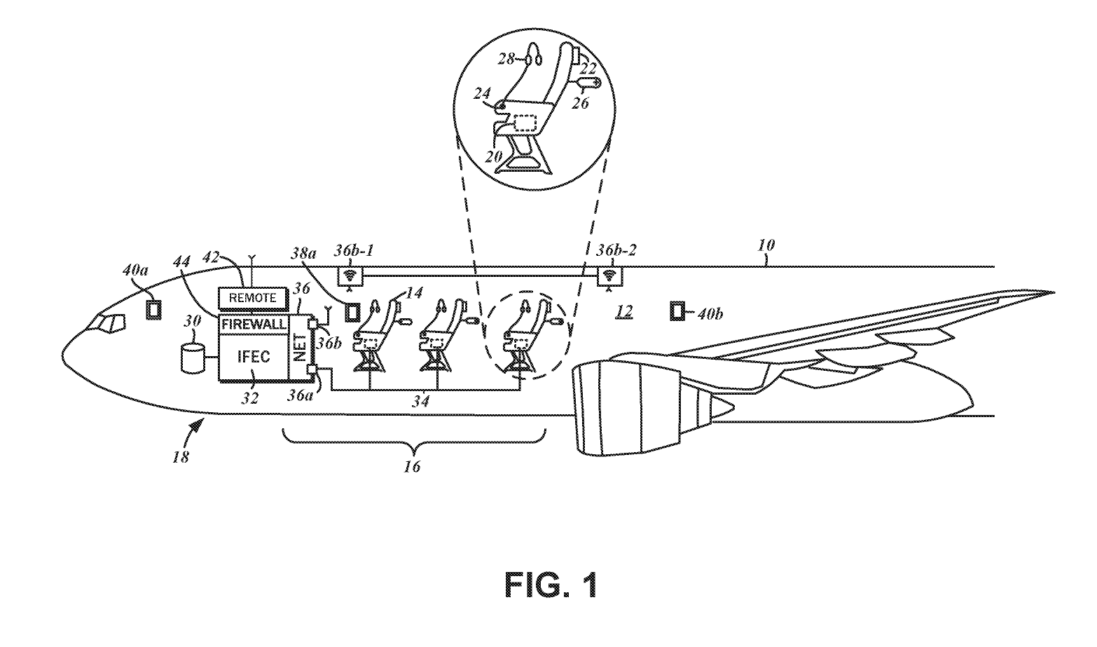

The diagram of FIG. 1 depicts an exemplary aircraft 10 in which various embodiments of the presently disclosed wireless content loader may be implemented. Within a fuselage 12 of the aircraft 10 there are seats 14 arranged over multiple rows 16, and each seat 14 accommodating a single passenger. Although the features of the present disclosure will be described in the context of the passenger aircraft 10 and amenities therefor, other passenger vehicles such as trains, watercraft, buses, and others utilizing integrated entertainment systems may be substituted.

The aircraft 10 incorporates an in-flight entertainment and communications (IFEC) system 18, through which various entertainment and connectivity services may be provided to passengers while onboard. A typical IFEC system 18 includes individual seat-back modules comprised of a terminal unit 20, a display 22, an audio output 24, and a remote controller 26. For a given row 16 of seats 14, the terminal unit 20 and the audio output 24 are disposed on the seat 14 for which it is provided, but the display 22 and the remote controller 26 may be disposed on the row 16 in front of the seat 14 to which it is provided. That is, the display 22 and the remote controller 26 are installed on the seatback of the row in front of the seat. This is by way of example only, and other display 22 and remote controller 26 mounting and access configurations such as a retractable arm or the like mounted to an armrest of the seat 14 or by mounting on a bulkhead.

The display 22 is understood to be a conventional liquid crystal display (LCD) screen with a low profile that is suitable for installation on the seatback. Each passenger can utilize an individual headset 28, supplied by either the airline or by the passenger, which provides a more private listening experience. In the illustrated embodiment, the audio output 24 is a headphone jack that is a standard ring/tip/sleeve socket. The headphone jack may be disposed in proximity to the display 22 or on the armrest of the seat 14 as shown. The headphone jack may be an active type with noise canceling and including three sockets or a standard audio output without noise canceling. In alternate embodiments, each display 22 may incorporate a terminal unit 20 to form a display unit referred to in the art as a smart monitor.

A common use for the terminal unit 20 installed on the aircraft is the playback of various multimedia content. The terminal unit 20 may be implemented with a general-purpose data processor that decodes the data files corresponding to the multimedia content and generates video and audio signals for the display 22 and the audio output 24, respectively. This multimedia content may include movies, television shows, such as news programs, comedy, documentaries, and informational content pertinent to the flight destination. Furthermore, multimedia content may also encompass audio-only programming, as well as interactive games, flight progress mapping, flight status displays, newspapers/magazines readable on the display 22, and so on. Broadly, multimedia content is intended to refer to any content of varying duration and form that can be presented to the passenger via the display 22 or the audio output 24, or a combination thereof.

The data files of the multimedia content may be stored in a database 30 associated with the IFEC system 18. Specifically, the database 30 and is connected to and managed by an IFEC server 32, which may be a specifically adapted general purpose computer system configured as a server to provide data in response to requests therefor. Various software modules are understood to be incorporated into the IFEC server 32, including a streaming server that retrieves the multimedia content from the database, as well as a cataloging/menu application with which the user interacts to select the desired multimedia content.

The passenger can play games being executed on the terminal unit and otherwise interact with the multimedia content with the remote controller 26. Navigating through the vast multimedia content library and selecting ones for viewing and/or listening is also possible with the remote controller 26, though in some embodiments, a touch-screen display may be provided for a more intuitive interaction with the multimedia content library. In either case, the terminal unit 20 is loaded with a content selection software application that is executed by the data processor and accepts input from the remote controller 26 or other input modality and generates a response on the graphical interface presented on the display 22.

Each of the terminal units 20 may be connected to the IFEC server 32 over an aircraft local area network 34, one segment of which may preferably be Ethernet. Thus, the IFEC server 32 includes a data communications module 36, and more specifically, an Ethernet data communications module 36a, e.g., an Ethernet switch or router.

One or more passengers may utilize a portable electronic device (PED) 38 during flight. For purposes of the present disclosure, passenger PEDs 38 refer to smart phones, tablet computers, laptop computers, and other like devices that include a general purpose data processor that executes pre-programmed instructions to generate various outputs on a display, with inputs controlling the execution of the instructions. Although these devices are most often brought on board the aircraft 10 by the passengers themselves, carriers may also offer them to the passengers for temporary use.

In addition to the passengers bringing the PEDs 38 on board for entertainment or productivity use, flight crew and cabin crew may likewise employ computing devices to carry out their respective duties during flight. For instance, the flight crew may utilize a crewmember PED 40a as an electronic flight bag (EFB). The cabin crew may be issued a crewmember PED 40b that is loaded with specific applications for managing cabin operations. Henceforth, the flight crew electronic flight bag and the cabin crew-issued devices will be referred to as crewmember PEDs 40, which are understood to encompass smart phones, tablet computer, laptop computers, and so forth.

Almost all conventional passenger PEDs 38 have a WLAN (Wi-Fi) module, so the data communications module 36 of the IFEC server 32 also includes a WLAN access point 36b. The PEDs 38, 40, via the onboard WLAN network, may connect to the IFEC server 32 to access various services offered thereon such as content downloading/viewing, shopping, and so forth.

Typically, a single WLAN access point 36b is insufficient for providing wireless connectivity throughout the cabin, so additional WLAN access points 36b-1 and 36b-2 may be installed at various locations spaced apart from each other. These additional WLAN access points 36b-1 and 36-b2 may be connected to the IFEC server 32 over an Ethernet link that is part of the aforementioned aircraft local area network 34. The local area network interface or data communications module 36 is understood to encompass the hardware components such as the WLAN transceiver 36b and the Ethernet router/switch 36a, as well as the software drivers that interface the hardware components to the other software modules of the IFEC server 32.

The IFEC system 18 may also offer Internet access to the connecting terminal units 20 as well as the PEDs 38, 40 during flight. In this regard, the IFEC server 32 may include a remote communications module 42 that establishes a remote data uplink, which in turn is connected to the Internet. The remote data uplink may be to a satellite, utilizing Ku-band microwave transmissions. Alternative satellite communications systems such as Inmarsat or Iridium may also be utilized. In another embodiment, the remote communications module 42 may be a cellular modem. The terminal unit 20 or the PEDs 38, 40 connect to the IFEC server 32 via the aircraft local area network 34 established by the data communications module 36, which relays the data transmissions to the remote communications module 42. Due to the high costs associated with the communications satellite or cellular networks in roaming mode, carriers may limit data traffic to and from the remote communications module 42 with a firewall 44.

The foregoing arrangement of the IFEC system 18, along with its constituent components, have been presented by way of example only and not of limitation. Those having ordinary skill in the art will recognize that the IFEC system 18 and its functional subparts can be arranged and organized in any number of different configurations. Furthermore, there may be additional components not mentioned herein, and certain functions may be handled by a different subpart or component than that to which the present disclosure attributes.

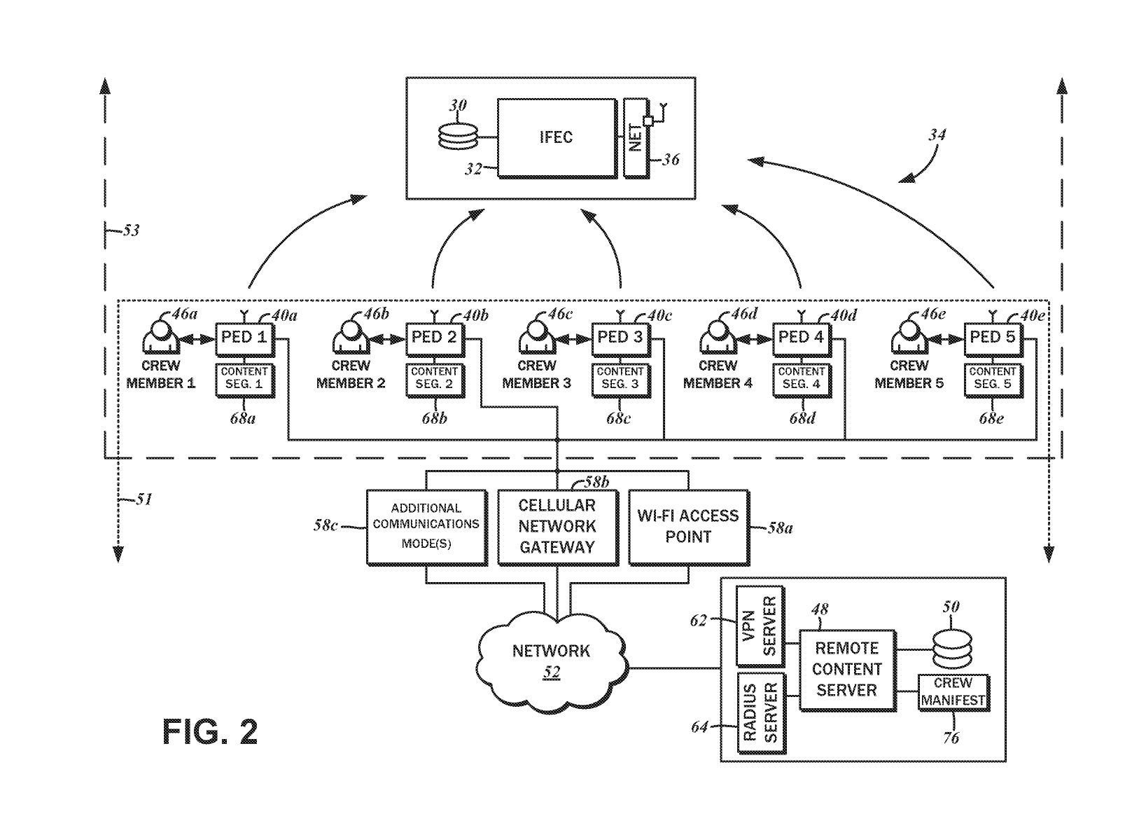

As mentioned above, there is a need to update the IFEC system 18 with updated multimedia content from time to time, and the present disclosure contemplates various modalities to this end. With reference to the block diagram of FIG. 2, per typical practice, the aircraft 10 is staffed with various crewmembers, including a first crewmember 46a, a second crewmember 46b, a third crewmember 46c, a fourth crewmember 46d, and a fifth crewmember 46e. Although no distinction is made herein with respect to the nature of the duties of each crewmember 46, they may generally be classified as flight crew that operate the aircraft, or cabin crew that help maintain the safety and comfort of passengers in the cabin. In some cases, the crewmember 46 may also include ground crew that provide aircraft maintenance services. The number of crewmembers 46 shown in FIG. 2 is by way of example only and not of limitation, and different flights have more or less crewmembers 46.

Each of the crewmembers 46a-46e are issued a respective crewmember PEDs 40a-40e, that is, the first crewmember 46a is assigned a first crewmember PED 40a, the second crewmember 46b is assigned a second crewmember PED 40b, the third crewmember 46c is assigned a third crewmember PED 40c, the fourth crewmember 46d is assigned a fourth crewmember PED 40d, and a fifth crewmember 46e is assigned a fifth crewmember PED 40e. In the presently contemplated system for distributing multimedia content, the crewmember PEDs 40a-40e need not be uniform with respect to the hardware device or the operating platform, though they are each understood to be capable of executing pre-programmed software instructions that implement various features of the system as will be described in further detail below. As indicated above, the crewmember PEDs 40 are configured with wireless data communications/networking modalities including Wi-Fi, which may be used to connect to an aircraft local area network 34 established by the data communications module 36 of the IFEC system 18.

The present disclosure contemplates the use of the crewmember PEDs 40 to retrieve updates to the multimedia content from a central repository while away from the aircraft 10, and once the crewmembers 46, by which such PEDs 40 are possessed, are onboard, in physical proximity to the aircraft 10 or in direct wireless communicable range to the data communications module 36 of the IFEC system 18, the multimedia content is transferred thereto. That is, the crewmember PEDs 40 are being utilized as a content loader. This transfer is understood to take place transparently and in the background during flight operations (whether on the ground or during flight) using the aircraft local area network 34.

As shown in FIG. 2, the aforementioned central repository of updated multimedia content may be implemented as a remote content server 48 that includes a content storage database 50. It is understood that the remote content server 48 is a conventional server computer system that is connected to a wide area network 52, to which the crewmember PEDs 40 also connects over various network modalities. According to one embodiment, the wide area network is the Internet, though any other suitable network may be substituted without departing from the scope of the present disclosure.

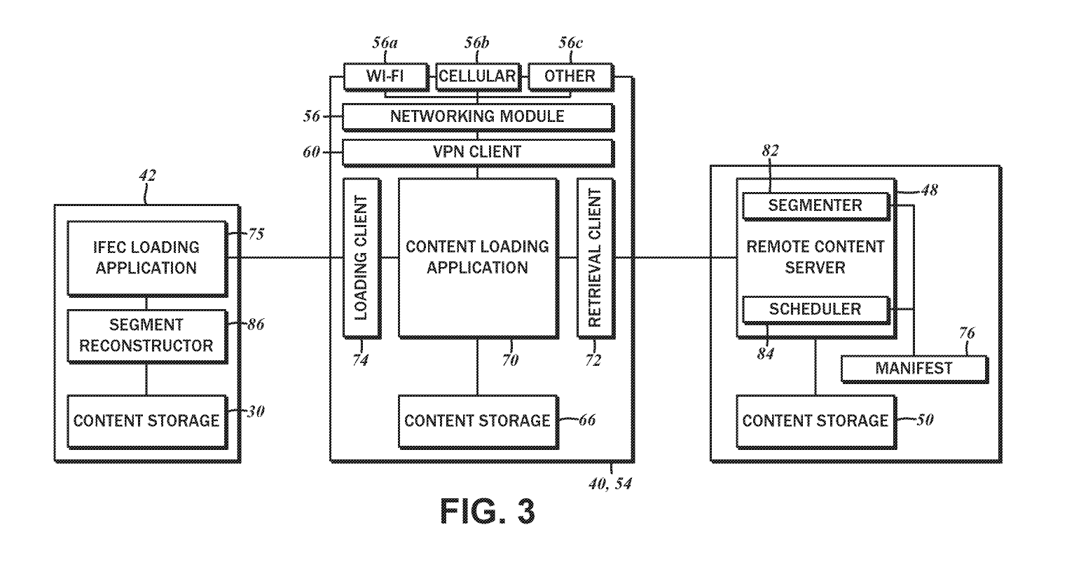

With reference to the block diagram of FIG. 3, the crewmember PEDs 40 establish a connection to the remote content server 48 when outside the direct wireless communicable range to the IFEC system 18 via one of several modalities, which is depicted as an area 51. The crewmember PED 40/content loader 54 includes a data networking module 56 that implements the various physical and electrical interfaces of the communications modalities, as well as the software protocol stacks of the same. The data networking module 56 can be segregated into different submodules that correspond to the communications modalities, including a Wi-Fi module 56a, a cellular module 56b, and other modules 56c. These modules of the content loader 54 are understood to connect to corresponding access points that serve as a gateway to the wide area network 52. Referring again to FIG. 2, this includes a Wi-Fi access point 58a, a cellular network gateway 58b, and an access point for other communications modules 58c.

The Wi-Fi module 56a and the Wi-Fi access point 58a to which it connects implements the physical interfaces and protocol stacks as defined under the Institute of Electrical and Electronics Engineers (IEEE) 802.11 standards, also known in the art as WLAN. In order to ensure compatibility with all possible Wi-Fi access points that may be encountered, the Wi-Fi module 56a is understood to have both 2.4 GHz and 5 GHz modes, and implement all existing 802.11 standards, including a, g, n, and ac protocols. The Wi-Fi module 56a may be connected to one or more antennas, and preferably three so that 3×3 MIMO (Multiple-In, Multiple-Out) Operation is possible. The Wi-Fi module 56a may also be referred to as a primary data networking module in some embodiments. In such embodiments, the Wi-Fi module 56a is utilized to connect to both the IFEC system 18 as well as the remote content server 48.

The second communications modality, as mentioned above, is cellular/mobile communications. A wide variety of technologies and standards for cellular data communications are deployed around the world, and to ensure interoperability, the cellular module 56b may be configured for different cellular technologies/technology families. One such cellular technology is GSM/EDGE (Global System for Mobile Communications/Enhance Data Rates for GSM Evolution). The data service of EDGE is also referred to as GPRS (General Packet Radio Service), and is likewise implemented in cellular module 56b. The latest advancement is also referred to as 4G LTE (Long Term Evolution), and a layer-1 data rate up to 500 Mbit/s is envisioned.

There are two existing transmission technologies with LTE—Frequency Division Duplex (FDD) and Time Division Duplex (TDD). Different countries have varying frequency allocations, so the cellular module 56b is configured for different FDD transmissions between the 700 MHz band and the 2600 MHz band, including the 700 MHz band, the 800 MHz band, the 900 MHz band, the 1800 MHz band, the 1900 MHz band, and the 2100 MHz band in particular. Earlier GSM-based systems such as UMTS (Universal Mobile Telecommunications System) with operating frequencies in the 850 MHz band, the 900 MHz band, the 1900 MHz band, and the 2100 MHz band may also supported. Furthermore, operation in the AWS band and the 800 MHz band may be possible.

An alternative cellular technology that may also be implemented in the cellular module 56b is W-CDMA (Wideband Code Division Multiple Access), the third generation (3G) data service component of which is known in the art as HSPA+ (Evolved High Speed Packet Access). The cellular module 56b of the content loader 54 is understood to connect to the cellular network gateway 58b to access the wide area network 52.

Another communications mode of the content loader 54 may conform to IEEE 802.16 standards (frequently referred to as WiMAX) or other standard such as WiBro that is common in South Korea, or other proprietary standard. The submodule of the data networking module 56 implemented in the content loader 54 for such alternative communications mode is identified as other modules 56c, while the access point to which such module connects being shown in FIG. 2 as other communications modules 58c.

Regardless of whether Wi-Fi, cellular network, or other modalities are utilized to establish the data transfer link with the remote content server 48, in some embodiments, all transmissions between the content loader 54 and the remote content server 48 may take place over a virtual private network (VPN). To this end, as shown in the block diagram of FIG. 3, the content loader 54 may include a VPN client 60, and there may be a corresponding VPN server 62 at the remote content server 48.

The virtual private network encrypts all data traffic between the content loader 54 and the remote content server 48, and is understood to be Cisco IPSec-compliant. Different implementations of VPN may be utilized, with multiple VPN tunnels being supported. Different cryptographic functions to ensure data integrity such as SHA-1 (secure hash algorithm), MD5, and RSA may be provided, and multiple encryption modalities are contemplated, including DES, 3DES, and AES. Authentication may be performed over the RADIUS (Remote Authentication Dial In User Service) protocol to an existing remote RADIUS server 64.

Securing the transmissions between the content loader 54 and the remote content server 48 with the VPN is presented by way of example only and not of limitation. Any other network security modality may be substituted without departing from the scope of the present disclosure.

Again, the content loader 54 retrieves updates of the multimedia content stored on the remote content server 48 when it is outside the wireless communication range of the IFEC system 18, and when the various access points 58 are available. In the exemplary context of airline transport, the crewmembers 46 are understood to have layovers of varying durations between flights on which they are assigned. Some layovers are of relatively short duration typically in the range of a few hours. In such case, the content loader 54 or crewmember PED 40 may establish a connection to an airport Wi-Fi access point to connect to the wide area network 52 and eventually to the remote content server 48. Other layovers, particularly with long international flights, may be much longer, typically in the range of a day or more. In this case, the content loader 54 or crewmember PED 40 may establish a connection to a hotel Wi-Fi access point to connect to the wide area network 52. Alternatively, should a Wi-Fi access point be unavailable, the cellular networks may be utilized. Which communications modality to be used may depend on the specific location and whether expensive roaming charges would apply, and the default selection of the communications modality may be set within the operating system of the crewmember PED 40. The use of both Wi-Fi and cellular modalities is also possible.

As shown in the block diagram of FIG. 3, the content loader 54/crewmember PED 40 is understood to include a content storage 66, also referred to herein as a content memory. Upon connecting to the remote content server 48, updates to the multimedia content may be downloaded and temporarily saved in the content storage 66 for subsequent transfer to the IFEC system 18.

In accordance with various embodiments of the present disclosure, it is also possible to distribute different segments of the multimedia content across multiple content loaders 54. The example of FIG. 2 illustrates five crewmembers 46a-46e, which each assigned crewmember PEDs 40a-40e, respectively. The content storage 66 of each of the crewmember PEDs 40 is understood to have a fifty (50) gigabyte capacity. Each of the crewmember PEDs 40 may be loaded with a different unique segment of the multimedia content. That is, the first crewmember PED 40a may store a first segment 68a of the multimedia content, the second crewmember PED 40b may store a second segment 68b of the multimedia content, the third crewmember PED 40c may store a third segment 68c of the multimedia content, the fourth crewmember PED 40d may store a fourth segment 68d of the multimedia content, and the fifth crewmember PED 40e may store a fifth segment 68e of the multimedia content.

With five crewmember PEDs 40 that are brought on board the aircraft 10, a total of two hundred and fifty (250) gigabytes may be loaded on to the IFEC system 18 during one flight leg. As such, it is possible to load one terabyte of data within four flight legs, which corresponds to approximately two days for a long haul aircraft. Conventionally, monthly updates are provided four days in advance, so adherence to this schedule is possible with the presently contemplated embodiments of the content loaders 54, and can also be improved. Data uploads of smaller increments is possible, rather than one large single-session update. Alternatively, the monthly content update (which may be as large as one terabyte) may be extended over the entire month, requiring incremental updates of only thirty five (35) gigabytes each session. This size is well within the capacity of most existing crewmember PEDs 40.

Besides the capacity of the content storage 66 on the crewmember PED 40, another limitation may be the available time and/or bandwidth needed to download file sizes up to fifty (50) gigabytes. With content updates spaced out over the span of an entire month, thirty five (35) gigabytes per day is typical for a one terabyte monthly update schedule. With five crewmembers, each crewmember PED 40 stores and updates seven (7) gigabytes in each segment 68 of the multimedia content, which is understood to be a reasonable demand for overnight downloads.

Referring to the block diagram of FIG. 3, in addition to the foregoing data communications components, the content loader 54 is understood to include a content loading application 70 that may be implemented as a set of computer-executable instructions that performs functions in accordance with the various aspects of the present disclosure. In further detail, the content loading application 70 may include a data retrieval client 72 that interfaces with the remote content server 48. The content loading application 70 also includes a data loading client 74 that interfaces with the IFEC server 32, and specifically an IFEC loading application 75 running thereon.

Although the present disclosure refers to the crewmember PED 40 and the content loader 54 interchangeably, the definitions thereof are not intended to be co-extensive. That is, the content loader 54 may also be a dedicated device with the aforementioned content memory and a processor pre-programmed with instructions that embody the content loading application 70 including the data retrieval client and the data loading client 74. Such a device may be brought on board by a selected ground crewmember during ground maintenance/flight preparation procedures in between flights. Like the counterpart crewmember PEDs 40, the content loader 54 may include a battery that is charged at a docking station when not in use, as well as connect to the remote content server 48 to download the multimedia content as needed for the next assigned aircraft/flight.

The data retrieval client 72, without user intervention and in response to detecting the establishment or existence of the primary remote data transfer link to the remote content server 48, transmits a content reception availability command to the remote content server 48. This is understood to be automated and occurs in the background without the crewmember 46 being prompted. There may be embodiments, however, where an alert is generated upon establishing the network link, followed by a request to provide an input as to whether the content updates are to proceed or not. A default of either proceed or not proceed may be set for such prompt, where a lack of a response defaults to one course of action or another. The content reception availability command may take a variety of forms, including a specific command that is received and processed by the remote content server 48, as well as a flag that is set in an application programming interface to the data retrieval client 72 and occasionally queried from the remote content server 48.

In response to the content reception availability command, the remote content server 48 transmits selected multimedia content to the data retrieval client 72. The identity of the crewmember PED 40/content loader 54 may be included in the content reception availability command to indicate to the remote content server 48 the crewmember 46 with which the crewmember PED 40 is associated. In some embodiments, the particular crewmember 46 and/or the crewmember PED 40 associated therewith is tracked in a crewmember manifest 76, along with aircraft or flight assignments for each crewmember. Thus, when a particular crewmember PED 40 establishes a connection to the remote content server 48, it is possible for the remote content server 48 to determine the next aircraft to which the crewmember PED 40 will be connected, along with which specific multimedia content is to be transferred thereto. To the extent there are multiple crewmembers 46, the remote content server 48 segments the multimedia content into multiple parts, with each part being designated for a particular crewmember PED 40. This function may be performed by a content segmenter 82.

Instead of utilizing the crewmember manifest 76, each crewmember PED 40 may include a home airport designator. Based upon the assumption that one set of crewmembers typically fly together and thus return home together, the remote content server 48 may load the multiple segments 68 of the multimedia content to those crewmember PEDs 40 with the same home airport designator.

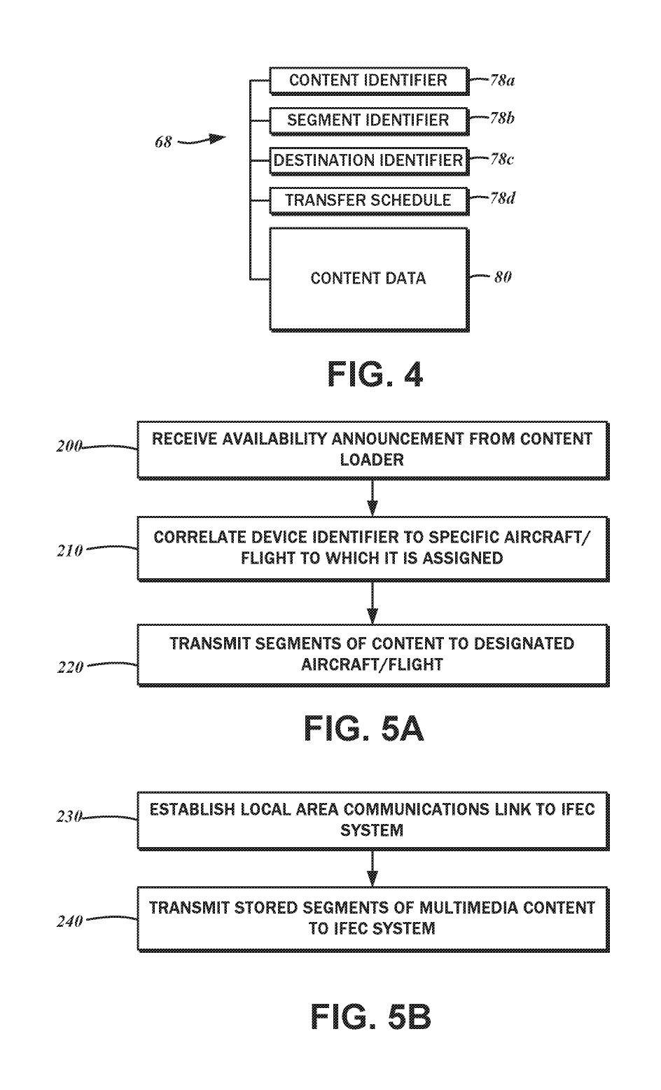

The data structure diagram of FIG. 4 illustrates one contemplated embodiment of a segment 68 of the multimedia content. There is a content identifier field 78a that uniquely identifies the multimedia content, and may be a numeric or alphanumeric character sequence. Furthermore, there is a segment identifier field 78b that identifies the specific segment 68 amongst the sequence of multiple segments. There may also be a destination identifier 78c, which may identify the final destination aircraft 10, the intermediate destination content loader 54, or a combination of both. The values for these fields may be generated by the content segmenter 82. The segment 68 of the multimedia content also includes the content data 80 itself.

The foregoing procedure of connecting to the remote content server 48 and retrieving different segments 68 of the multimedia content is understood to take place independently for each separate crewmember PED 40, and the retrieval of the multimedia content by one crewmember PED 40 is not dependent on another. That is, the remote content server 48 can maintain a listing of all of the separate segments that have been transferred to different crewmember PEDs 40, and to the extent there are no additional crewmember PEDs 40 available to accept the segment, such segment may be queued for a subsequent transfer when a crewmember PED 40 that has already accepted one of the earlier segments again becomes available after completing the last transfer to the IFEC system 18. The order and timing in which the segments 68 are transferred to the multiple content loaders 54 may be set by a scheduler 84.

As noted previously, the content loading application 70 also includes the data loading client 74, which interfaces the content loader 54 to the IFEC server 32. Specifically, the IFEC server 32 includes the IFEC loading application 75 that receives the transmitted segments 68 from the data loading client 74. Again, this transmission is understood to take place over the aircraft local area network 34, and can begin automatically without user invention once the crewmember PED 40 is brought within direct wireless communication range of the aircraft local area network 34, which is depicted as area 53 in the block diagram of FIG. 2. Upon verification of the various fields 78a-c and the completed transfer of the entirety of the content data 80, the IFEC loading application 75 transmits a confirmation to the content loader 54. A more detailed log with entries showing the transferred multimedia content may also be transmitted to the content loader 54 for relaying to the remote content server 48. Along these lines, data to be offloaded from the IFEC system 18 may likewise be transmitted to the content loader for transmission to the remote content server 48. While such data is typically of such a small size that storage space in the memory of the crewmember PED 40 is more than sufficient, if necessary, the IFEC loading application 75 may include a segmenter along the same lines as the content segmenter 82 to distribute such data across multiple content loaders 54. When the content loader 54 connects again to the remote content server 48, the confirmation may be passed thereto so that the same content data is not loaded on the particular IFEC system 18 again, along with the other data mentioned above.

The transmission of one of the segments 68 of the multimedia content to the IFEC server 32 from one content loader 54 is understood to be independent of the transmission of a different segment from another content loader 54. The schedule in accordance with which the transmissions are initiated may be staggered by time, or by flight legs, with such schedule being set by the scheduler 84 and defined within a transfer schedule field 78d in the segment 68. The multiple segments 68 received by the IFEC loading application 75 is then reconstructed by a content reconstructor 86 before the completed multimedia content is stored in the database 30.

The content loader 54, as well as the IFEC server 32 and the remote content server 48 have been described above in terms of the various functional modules thereof. Different embodiments of the content loader 54, the IFEC server 32, and the remote content server 48, while incorporating the same general functional features as described above, may rely upon different components performing different subsets or combinations of such functions. In other words, the features and sub-components of the content loader 54, the IFEC server 32, and the remote content server 48 can be organized along different functional demarcations.

Referring to the flowchart of FIG. 5A, another embodiment of the present disclosure contemplates a method for distributing multimedia content to the IFEC system 18 of the aircraft 10. This method will also be described with reference to the various components and features of the system for distributing multimedia content as shown in FIGS. 2 and 3. There is a step 200 of receiving the first availability announcement from a first content loader 54/crewmember PED 40a. The first availability announcement, as mentioned above, is transmitted from the content loader 54 to the remote content server 48, and may take any form that enables the remote content server 48 to ascertain that the content loader 54 is ready to receive the multimedia content. The first availability announcement includes a device identifier that is associated with the first content loader 54/crewmember PED 40a.

Next, in a step 210, the first device identifier is correlated to an aircraft identifier that is listed in the crewmember manifest 76 stored in the remote content server 48. Generally, a given aircraft 10 is assigned one or more crewmembers 46, and so the record entries of the crewmember manifest may list each of the aircraft in a carrier's fleet, with the listing of the crewmembers 46 being subsidiary to the record of the aircraft 10 or flight. Alternatively, the manifest may be a flat listing of all of the crewmembers 46 of the carrier, with flight or aircraft assignments being an attribute thereof. Any other data structure of the crewmember manifest 76, along with the appropriate processing steps thereof to correlate the crewmember 46 to a specific aircraft 10 or flight may be substituted without departing from the scope of the present disclosure.

Upon the destination content loader 54 being identified, the method continues with a step 220 of transmitting the one or more segments 68 of the multimedia content thereto. Upon receipt by the first content loader 54/crewmember PED 40a, it may be stored in the content storage 66 thereof.

The foregoing method is described in the context of the remote content server 48, though it will be appreciated that there are corollary steps in the context of the content loader 54. Another aspect of the disclosed method includes steps that are performed by the content loader 54 in conjunction with the IFEC system 18, and the flowchart of FIG. 5B illustrates such method.

The aforementioned step 220 of transmitting the one or more segments 68 of the multimedia content has a corollary receiving step of the same on the content loader 54. Thereafter, in a step 230, the method includes establishing a local area communications link, e.g., connecting to the aircraft local area network 34 from the content loader 54. Then, there is a step 240 of transmitting the segments 68 of the multimedia content from the content loader 54 to the IFEC system 18.

Each of the foregoing steps may be repeated for a second content loader 54/crewmember PED 40b, with such steps being executed independently of the first content loader 54/crewmember PED 40a.

The particulars shown herein are by way of example and for purposes of illustrative discussion of the various embodiments of the content loader only and are presented in the cause of providing of what is believed to be the most useful and readily understood description of the principles and conceptual aspects thereof. In this regard, no attempt is made to show more details than are necessary for a fundamental understanding of the disclosure, the description taken with the drawings making apparent to those skilled in the art how the several forms of the presently disclosed illumination module may be embodied in practice.

1. A content loader device for transferring data from a remote content server to an entertainment system of a vehicle, the content loader device comprising:
a content memory;
a primary data networking module that establishes a local data transfer link to the entertainment system while being within direct wireless communicable range thereto, and a primary remote data transfer link to the remote content server while being beyond direct wireless communicable range to the entertainment system;
a data retrieval client linked to the content memory and the primary data networking module, the data retrieval client, without user intervention and in response to a detected establishment of the primary remote data transfer link, transmits a content reception availability command to the remote content server over the primary remote data transfer link, which in response transmits the data to the data retrieval client over the primary remote data transfer link based upon a manifest associating the content loader device to the vehicle, the data being stored in the content memory; and
a data loading client linked to the content memory and the primary data networking module, the data loading client, without user intervention and in response to a detected establishment of the local data transfer link, transmits the data to the entertainment system following retrieval from the content memory.

2. The content loader device of claim 1, further comprising:
a secondary data networking module that establishes a secondary remote data transfer link to the remote content server.

3. The content loader device of claim 2, wherein
the data retrieval client, without user intervention and in response to a detected establishment of the secondary remote data transfer link, transmits the content reception availability command to the remote content server over the primary remote data transfer link, which in response transmits the data to the data retrieval client over the primary remote data transfer link based upon the manifest, the data being stored in the content memory.

4. The content loader device of claim 2, wherein:
the primary data network module is a wireless local area network (WLAN) communications module; and
the secondary data networking module is a cellular communications module.

5. (canceled)

6. The content loader device of claim 1, wherein the data retrieval client communicates with the entertainment system to retrieve data stored thereon for transmission to a remote server.

7. The content loader device of claim 1, wherein the data loading client maintains a log of the data transmitted to and stored on the entertainment system, the log being transmitted to the remote content server upon availability of the primary data transfer link.

8. A system for wirelessly distributing data to an in-flight entertainment system of an aircraft, the system comprising:
a remote content server on which the data is stored; and
one or more content loader devices each assigned to a flight crew member and each including:
a data retrieval module that announces an availability to accept the data from the remote content server upon establishing a remote data communications link to a wide area network connected to the remote content server, in response to the announcement the remote content server selectively transmitting the data to a specific one of the one or more content loader devices based upon a crewmember manifest maintained by the remote content server associating the specific one of the one or more content loader devices with the aircraft; and
a data loading module that transmits the data to the in-flight entertainment system over a local wireless data communications link to the in-flight entertainment system.

9. (canceled)

10. The system of claim 8, wherein a first one and a second one of the one or more content loader devices is associated with the aircraft in the crewmember manifest, a first segment of the data being transmitted to the first one of the one or more content loader devices and a second segment of the data being transmitted to the second one of the one or more content loader devices.

11. The system of claim 10, wherein the first one and the second one of the one or more content loader devices each establishes respective independent data communications links to the remote content server.

12. The system of claim 10, wherein transmission of the first segment of the data from the first one of the one or more content loaders to the in-flight entertainment system is staggered from transmission of the second segment of the data from the second one of the one or more content loaders to the in-flight entertainment system.

13. The system of claim 8, wherein transmission of one or more segments of the data from each content loader device is staggered over a plurality of flight legs.

14. The system of claim 8, wherein one of the content loader devices is a mobile communications device including a primary wireless communications module, the primary wireless communications module establishing the local wireless data communications link and the remote data communications link.

15. The system of claim 14, wherein the mobile communications device includes a secondary wireless communications module that establishes the remote data communications link.

16. A method for distributing data to an in-flight entertainment system of an aircraft, the method comprising:
receiving, on a content server computer system over a first remote data communications link, a first availability announcement from a first content loader device issued to a first aircraft crewmember, the first availability announcement including a first device identifier associated with the first content loader device;
correlating the first device identifier with an aircraft identifier listed in a crewmember manifest stored on the content server computer system; and
transmitting one or more first segments of the data to the first content loader device, the one or more first segments of the data being designated for transmission to an aircraft to which the first device identifier is correlated.

17. The method of claim 16, further comprising:
establishing a local area communications link between the first content loader device and the in-flight entertainment system; and
transmitting the one or more first segments of the data from the first content loader device to the in-flight entertainment system.

18. (canceled)

19. The method of claim 16, further comprising:
receiving, on the content server computer system over a second remote data communications link, a second availability announcement from a second content loader device issued to a second aircraft crewmember, the availability announcement including a second device identifier associated with the second content loader device;
correlating the second device identifier with the aircraft identifier listed in the crewmember manifest stored on the content server computer system;
transmitting one or more second segments of the data different from the one or more first segments of the data to the second content loader device.

20. The method of claim 19, wherein the step of transmitting the one or more first segments of the data from the first content loaders to the in-flight entertainment system is staggered from the step of transmitting the one or more second segments of the data from the second content loader to the in-flight entertainment system.

21. The content loader device of claim 1, wherein said data comprises multimedia content.

22. The system of claim 8, wherein said data comprises multimedia content.

23. The method of claim 16, wherein said data comprises multimedia content.
